(19) United States
(12) Patent Application Publication
(10) Pub. No.: US 2013/0020157 A1
(43) Pub. Date: Jan. 24, 2013

(54) PASSIVE INERT GAS BRAKING APPARATUS, SYSTEM AND METHOD FOR BRAKING A FLYWHEEL ROTATING WITHIN AN ELECTROMECHANICAL BATTERY SYSTEM AND RELATED SYSTEMS AND METHODS

(71) Applicants: Philip J. SCALZO, North Salt Lake, UT (US); Carleton D. TAIT, North Salt Lake, UT (US)

(72) Inventors: Philip J. SCALZO, North Salt Lake, UT (US); Carleton D. TAIT, North Salt Lake, UT (US)

(73) Assignee: EMB Energy, Inc., Edmonton, OK (US)

(21) Appl. No.: 13/531,109

(22) Filed: Jun. 22, 2012

Related U.S. Application Data
(60) Provisional application No. 61/500,382, filed on Jun. 23, 2011.
(60) Provisional application No. 61/500,405, filed on Jun. 23, 2011.
(60) Provisional application No. 61/500,355, filed on Jun. 23, 2011.
(60) Provisional application No. 61/500,370, filed on Jun. 23, 2011.
(60) Provisional application No. 61/500,394, filed on Jun. 23, 2011.

(51) Int. Cl. F16D 63/00

(52) U.S. Cl. 188/272

(57) ABSTRACT

A passive inert gas braking apparatus, system and method for braking a flywheel rotating within an electromechanical battery (EMB) system includes an electro-mechanical battery arrangement having a containment vessel containing a flywheel, a compressed gas storage arrangement to store compressed gas, a gas expansion arrangement to receive gas from the vessel, which is coupled to the storage arrangement, in which the vessel is coupled to the gas expansion arrangement, and in which the gas expansion arrangement is coupled to the compressor arrangement. Also described is a method for braking a flywheel rotating in an electromechanical battery (EMB) system by providing a compressed gas to an electro-mechanical battery arrangement having a containment vessel containing a rotating flywheel to slow the rotating flywheel, and after the flywheel has at least slowed because of the gas in the containment vessel, returning heated gas from the containment vessel to a gas expansion arrangement.

### RELATED APPLICATION INFORMATION

The present application is a utility application of and claims the benefit of and priority to U.S. Provisional Patent Application Ser. No. 61/500,382, filed Jun. 23, 2011 (attorney docket no. 15223/5), which is hereby incorporated by reference. The present application is also a utility application of and claims the benefit of and priority to U.S. Provisional Patent Application Ser. No. 61/500,405, filed Jun. 23, 2011 (attorney docket no. 15223/8), which is hereby incorporated by reference. The present application is also a utility application of and claims the benefit of and priority to U.S. Provisional Patent Application Ser. No. 61/500,355, filed Jun. 23, 2011 (attorney docket no. 15223/2), U.S. Provisional Patent Application Ser. No. 61/500,370, filed Jun. 23, 2011 (attorney docket no. 15223/3), and U.S. Provisional Patent Application Ser. No. 61/500,394, filed Jun. 23, 2011 (attorney docket no. 15223/6), all of which are hereby incorporated by reference.

### FIELD OF THE INVENTION

The present invention relates to a passive inert gas braking apparatus, system and method for braking a flywheel rotating within an electromechanical battery (EMB) system, including in a vacuum.

### BACKGROUND INFORMATION

The Electro-Mechanical Battery (EMB) is a bulk electric energy storage device that is believed to provide a practical solution to many of the shortcomings of renewable energy technologies, such as the diurnal nature of wind and solar intermittency. The EMB should be considered an enabling technology because of its economically competitive ability to level net power delivery to the electric grid, resulting in a higher transmission line utilization factor.

Electromechanical Batteries (EMB) may store considerable amounts of energy in the form of kinetic energy imparted to a rotating flywheel. For example, in an EMB Energy system at full charge, there may be more than 900 MJ or 300 kWhs of energy stored in the 2000 Kg flywheel rotating at nearly 14,000 RPM.

Such high-energy flywheels enclosed in a vacuum containment vessel of an electro-mechanical battery (EMB) may rotate for potentially thousands of hours unless some form of braking force is applied. Under normal operating conditions, this braking force results from the extraction of energy via the EMB's electric generator. However, alternative braking may be required under various emergency conditions, including seismic activity.

Even minute degradations of the flywheel my cause imbalances that can result in vibrations or, periodic mechanical oscillations around equilibrium point. In a lightly damped system such as an operating EMB, when the forcing frequency nears the natural frequency the amplitude of the vibration can get extremely high. This phenomenon is called resonance (subsequently the natural frequency of a system is often referred to as the resonant frequency). In rotor bearing systems any rotational speed that excites a resonant frequency is referred to as a critical speed. If resonance occurs in the EMB, it can be very harmful—leading to eventual failure of the system. Consequently, a breaking or auxillary braking system is desirable to prevent or mitigate forced vibrations that could lead to the catastrophic failure of the system.

Counter-rotational breaking forces may be applied through various mechanical arrangements (such as, for example, a friction clutch), but considerable localized heat will be generated that will rapidly degrade the contact surfaces. Further, heat transfer from the friction surface must be removed promptly through conduction or convection before the surface materials and adjoining structures achieve temperatures that may exceed their physical limits or otherwise cause excess temperature damage.

The kinetic energy stored in the EMB flywheel is proportional to the square of its rotational velocity (w). To substantially slow a flywheel (for example, by half), where ω₂=½ω₁, {1−(½)²}, on the order of about ¾ of the kinetic energy in the flywheel must be removed through friction that will ultimately be manifested as heat.

The flywheel of the EMB may include a thick-walled cylinder made of filament wound glass and carbon fiber. Under normal, steady-state operations, the EMB flywheel may be magnetically levitated, and the high rotational velocity of the flywheel causes it to present gyroscopic behavior. If magnetically levitated, the flywheel has no physical connection to its containment vessel, and it is able to rotate about its axis independent of the containment vessel.

While operating in a vacuum environment, the modes of heat transfer from mechanically braking the flywheel include conduction (from and through a clutch mechanism) and radiation. Neither heat transfer mode will likely be adequate to transfer all of the heat generated through localized contact friction. As a result, the mechanical clutch system may quickly heat until it fails.

Still further, if the flywheel is rotating on magnetic bearings, any radiated heat that is transferred to the permanent magnets will cause the temperature of the magnetic bearings to increase. At some point, when the temperature of the magnetic bearings exceeds the Curie Temperature T_{c} of the permanent magnet material, the bearings will lose their magnetism and the bearings will catastrophically fail.

### SUMMARY OF THE INVENTION

The exemplary embodiments and/or exemplary methods of the present invention relate to a passive gas braking apparatus for braking a flywheel rotating in an electromechanical battery (EMB) system, including: an electro-mechanical battery arrangement having a containment vessel containing a flywheel; a compressed gas storage arrangement to store compressed gas; a gas expansion arrangement to receive gas from the containment vessel; wherein the containment vessel is coupled to the compressed gas storage arrangement, wherein the containment vessel is coupled to the gas expansion arrangement, and wherein the gas expansion arrangement is coupled to the compressor arrangement.

The exemplary embodiments and/or exemplary methods of the present invention also relate to the foregoing system in which the inert gas includes nitrogen.

The exemplary embodiments and/or exemplary methods of the present invention also relate to the foregoing system, further including an input valve arrangement arranged on a conduit for allowing the gas into the containment vessel.

The exemplary embodiments and/or exemplary methods of the present invention also relate to the foregoing system, further including an output valve arrangement arranged on a conduit for extracting heated gas out of the containment vessel.

The exemplary embodiments and/or exemplary methods of the present invention also relate to the foregoing system, further including an input valve arrangement arranged on a conduit for allowing the gas into the containment vessel, and an output valve arrangement arranged on a conduit for extracting heated gas out of the containment vessel.

The exemplary embodiments and/or exemplary methods of the present invention also relate to the foregoing system, further including an actuatable ball valve and a magnetic valve arranged on a conduit for allowing the gas into the containment vessel.

The exemplary embodiments and/or exemplary methods of the present invention also relate to the foregoing system, further including a magnetic valve arranged on a conduit for extracting heated gas out of the containment vessel.

The exemplary embodiments and/or exemplary methods of the present invention also relate to the foregoing system, further including an actuatable ball valve and a magnetic valve arranged on a conduit for allowing the gas into the containment vessel, and a magnetic valve arranged on a conduit for extracting heated gas out of the containment vessel.

The exemplary embodiments and/or exemplary methods of the present invention also relate to the foregoing system, further including a heat exchanger arrangement to extract heat from the heated gas in the gas expansion arrangement.

The exemplary embodiments and/or exemplary methods of the present invention also relate to the foregoing system, wherein the containment vessel is coupled to the compressed gas storage arrangement by a gas conduit for providing stored compressed gas from the compressed gas storage arrangement to the containment vessel.

The exemplary embodiments and/or exemplary methods of the present invention also relate to the foregoing system, wherein the containment vessel is coupled to the gas expansion arrangement by a second gas conduit for extracting heated gas from the containment vessel and returning it to the gas expansion arrangement.

The exemplary embodiments and/or exemplary methods of the present invention also relate to the foregoing system, wherein the containment vessel is coupled to the compressed gas storage arrangement by a gas conduit for providing stored compressed gas from the compressed gas storage arrangement to the containment vessel, and wherein the containment vessel is coupled to the gas expansion arrangement by a second gas conduit for extracting heated gas from the containment vessel and returning it to the gas expansion arrangement.

The exemplary embodiments and/or exemplary methods of the present invention also relate to the foregoing system, further including an input valve arrangement arranged on the gas conduit for allowing the gas into the containment vessel, and an output valve arrangement arranged on the second gas conduit for extracting heated gas out of the containment vessel.

The exemplary embodiments and/or exemplary methods of the present invention also relate to the foregoing system, further including a heat exchanger arrangement to extract heat from the heated gas in the gas expansion arrangement.

The exemplary embodiments and/or exemplary methods of the present invention also relate to the foregoing system, further including a compressor arrangement to compress the gas, wherein the compressor arrangement is coupled to the compressed gas storage arrangement.

The exemplary embodiments and/or exemplary methods of the present invention also relate to a method for braking a flywheel rotating in an electromechanical battery (EMB) system, the method including: providing a compressed gas to an electro-mechanical battery arrangement having a containment vessel containing a rotating flywheel to slow the rotating flywheel; and after the flywheel has at least slowed because of the gas in the containment vessel, returning heated gas from the containment vessel to a gas expansion arrangement.

The exemplary embodiments and/or exemplary methods of the present invention also relate to the foregoing method, further including compressing a gas to provide the compressed gas.

The exemplary embodiments and/or exemplary methods of the present invention also relate to the foregoing method, wherein the compressed gas is fed from a compressed gas storage arrangement.

The exemplary embodiments and/or exemplary methods of the present invention also relate to the foregoing method, further including extracting, using a heat exchanger arrangement, heat from the heated gas in the gas expansion arrangement.

The exemplary embodiments and/or exemplary methods of the present invention also relate to the foregoing method, further including compressing a gas to provide the compressed gas; and extracting, using a heat exchanger arrangement, heat from the heated gas in the gas expansion arrangement, wherein the compressed gas is fed from a compressed gas storage arrangement.

The exemplary embodiments and/or exemplary methods of the present invention also relate to a method for braking a flywheel rotating in an electromechanical battery (EMB) system, the method including: compressing a gas to provide the compressed gas; providing the compressed gas to an electro-mechanical battery arrangement having a containment vessel containing a rotating flywheel to slow the rotating flywheel; after the flywheel has at least slowed because of the gas in the containment vessel, returning heated gas from the containment vessel to a gas expansion arrangement; and extracting, using a heat exchanger arrangement, heat from the heated gas in the gas expansion arrangement.

### BRIEF DESCRIPTION OF THE DRAWINGS

FIG. 1 shows an exemplary embodiment of a passive inert gas braking apparatus, system and method for braking a flywheel rotating within a vacuum of an electromechanical battery (EMB) system.

FIG. 2 shows a chart of flywheel (or rotor) rundown time versus chamber pressure.

### DETAILED DESCRIPTION

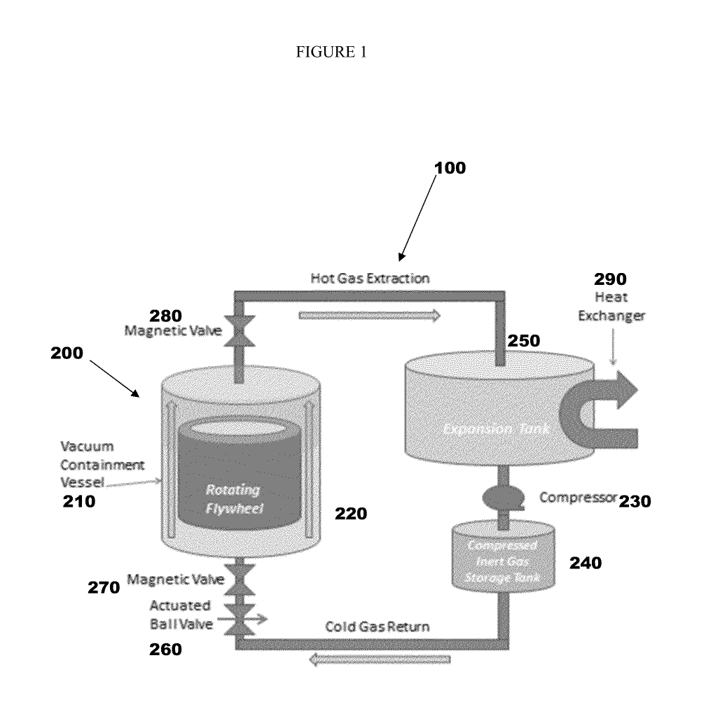

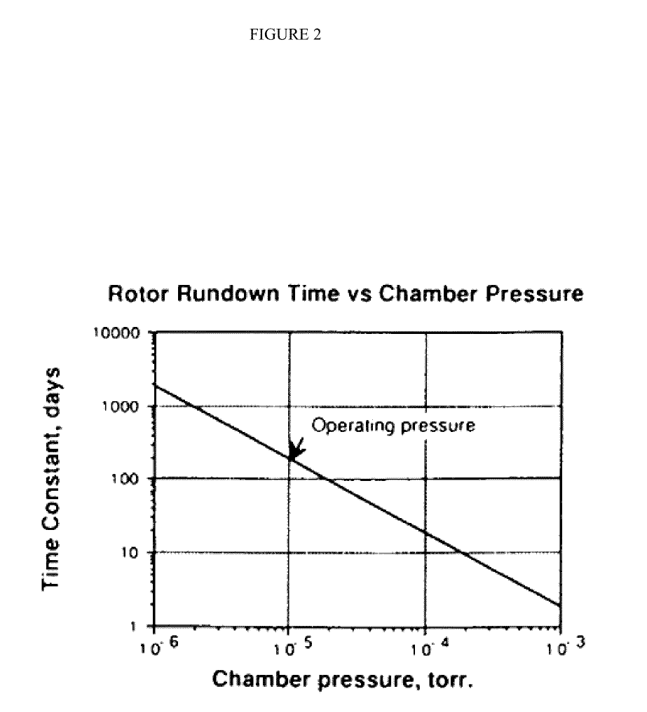

FIG. 1 shows an exemplary embodiment of a passive inert gas braking apparatus, system and method for braking a flywheel rotating within a vacuum for an electromechanical battery (EMB) system. FIG. 2 shows a chart of flywheel (or rotor) rundown time versus chamber pressure.

The flywheel of the EMB may include a thick-walled cylinder made of filament wound glass and carbon fiber. Under normal, steady-state operations, the EMB flywheel may be magnetically levitated, and the high rotational velocity of the flywheel causes it to present gyroscopic behavior. Because the flywheel has no physical connection to its containment vessel, it is able to rotate about its axis independent of the containment vessel.

In particular, FIG. 1 shows a passive gas braking apparatus 100 for braking a flywheel rotating in an electromechanical battery (EMB) system, including: an electro-mechanical battery arrangement having a containment vessel 210 containing a flywheel 220; a compressor arrangement 230 to compress a gas; a compressed gas storage arrangement 240 to store compressed gas; a gas expansion arrangement 250 to receive gas from the containment vessel 210, in which the containment vessel 210 is coupled to the compressed gas storage arrangement 240, in which the containment vessel 210 is coupled to the gas expansion arrangement 250, in which the gas expansion arrangement 250 is coupled to the compressor arrangement 230, and in which the compressor arrangement 230 is coupled to the compressed gas storage arrangement 240.

Under an appropriate condition when it is necessary to brake the flywheel, the stored compressed inert gas (which is colder than the expanded gas) in the compressed gas storage arrangement 240 (which is a tank or other gas storage arrangement) is released through a cold gas conduit (which couples the compressed gas storage arrangement and the vacuum containment vessel. In particular, the inert gas is transferred through the actuated ball valve 260 (which has been actuated by the control circuit (not shown)) and then through the magnetic gate valve 270 to the vacuum chamber of the vacuum containment vessel 210. The interaction between the inert gas and the internal rotating elements of the EMB creates drag, causing the flywheel 220 to slow and eventually stop. The heated gas is then released or extracted through a second magnetic gate valve 280. The heated gas is then transferred via an expanded or hot gas conduit to the gas expansion arrangement 250 (which is a tank or other gas storage arrangement). As the gas cools in the expansion arrangement 250 via a heat exchanger arrangement 290, it may be compressed via compressor 230 and stored in the compressed gas storage arrangement 240 for later re-use.

The exemplary embodiments and/or exemplary methods of the present invention provide for removing energy from the rotating flywheel 220 while maintaining the temperature within the containment vessel 210 at a safe level, which is less than T_{c}. The exemplary embodiments and/or exemplary methods of the present invention may include a combination of sensors, magnetic valves, high pressure tanks, compressors, and an inert gas.

When a control system (not shown) determines that conditions are such that the flywheel must be rapidly slowed or stopped, a signal is sent to the inlet magnetic valve and the outlet magnetic valve to open, at which point an inert gas (which may be, for example, nitrogen or argon) immediately flows into the vacuum containment vessel 210, initially driven by the extreme pressure differential (150 PSI to 2×10⁻⁷ PSI) until equilibrium is attained, and then by a circulating convective fluid flow (heat source to sink).

The inert gas, under pressure, creates considerable frictional forces through aerodynamic drag between the rotating flywheel 220 (with a rim speed that may approach several hundred to on the order of about 1,000 meters per second) and the inert gas transferring across the surface of the flywheel 220. The extreme “skin” frictional forces will generate heat that will be conducted off of the surface of the flywheel 220 to the working fluid (which is the inert gas) and will be eventually transferred through the heat exchanger 290 to the ultimate heat sink.

Skin friction arises from the friction of the fluid against the “skin” of the object that is moving through it. Skin friction arises from the interaction between the fluid and the skin of the body, and is directly related to the area of the surface of the body that is in contact with the fluid. Skin friction follows the drag equation and rises with the square of the velocity, as follows:

F_{D}=½ρu²C_{D}A

where, F_{D} is the force of drag, which is by definition the force component in the direction of the flow velocity, ρ is the mass density of the fluid, u is the velocity of the object relative to the fluid, A is the reference area, and C_{D} is the drag coefficient—a dimensionless constant.

The reference area A is typically defined as the area of the orthographic projection of the object on a plane perpendicular to the direction of motion. In the case of a rotating cylinder encompassed by an inert heavy gas (the fluid, such as, for example, nitrogen gas), the resulting drag force F_{D}, will oppose the rotational motion of the flywheel, causing angular deceleration that can be described by

$$α = \frac{d ω}{d t} = \frac{{d}^{2} θ}{d {t}^{2}} , or α = \frac{{a}_{T}}{r} ,$$

Where, ω is the angular velocity, α_{T} is the linear tangential deceleration, and r is the distance from the origin of the coordinate system that defines θ and ω to the point of interest. Newton's second law can be adapted to describe the relation between torque and angular acceleration, as follows: τ=I α, where τ is the total torque exerted on the body, and I is the mass moment of inertia of the body.

The Power or in this case the rate of energy extraction from the flywheel resulting from the aerodynamic drag, is described by P_{d}=½ρω³AC_{d}. The instantaneous rate of energy transfer from the flywheel 220 to the working fluid varies as the cube of the rotational velocity.

The exemplary embodiments and/or exemplary methods of the present invention provide for introducing the working fluid into the system so as to maximize the turbulence exhibited at the fluid/solid boundary. When flow is turbulent, the particles exhibit additional transverse motion which enhances the rate of energy and momentum exchange between them thus increasing the heat transfer and the friction coefficient. As the rotational velocity of the flywheel decreases, there will be a propensity, if all other things are held constant, for the flow to become laminar where a thin “film” of inert gas would form at the gas/solid boundary, effectively “lubricating” the flywheel with respect to the balance of the inert gas within the containment vessel.

The stochastic property changes that are characteristic of turbulent fluid flows are, however, maintained during flywheel deceleration. This includes low momentum diffusion, high momentum convection, and rapid variation of fluid pressure and fluid velocity.

The exemplary embodiments and/or exemplary methods of the present invention leverage the inherent (passive) temperature and pressure gradients across the axial dimension of the flywheel resulting from the introduction of cooled inert gas into the containment vessel.

An active system having a controller arrangement monitors the real-time conditions within the vessel and, as required, adjusts the velocity and pressure of the gas passing though the containment vessel's lower orifice. The velocity and pressure are specifically adjusted by the controller arrangement (including a circuit arrangement) by opening and closing an actuated ball valve 260 that precedes the magnetic gate valve 270.

The foregoing systems and methods can be used with the apparatus, system and method for detecting anomalous axial displacements of a magnetically levitated flywheel in an electro-mechanical battery (EMB) system, as described in concurrently filed and co-pending utility patent application Ser. No. ______ entitled “APPARATUS, SYSTEM AND METHOD FOR DETECTING ANOMALOUS AXIAL DISPLACEMENTS OF A MAGNETICALLY LEVITATED FLYWHEEL IN AN ELECTROMECHANICAL BATTERY SYSTEM” (Attorney Docket No. 15223/9), filed Jun. 22, 2012, which is hereby incorporated by reference.

The foregoing systems and methods can be used with the apparatus, system and method for detecting anomalous axial displacements of a magnetically levitated flywheel in an electro-mechanical battery (EMB) system, as described in concurrently filed and co-pending provisional patent application Ser. No. 61/500,405 entitled “APPARATUS, SYSTEM AND METHOD FOR DETECTING ANOMALOUS AXIAL DISPLACEMENTS OF A MAGNETICALLY LEVITATED FLYWHEEL IN AN ELECTROMECHANICAL BATTERY SYSTEM” (Attorney Docket No. 15223/8), filed Jun. 23, 2011, which is hereby incorporated by reference.

The foregoing systems and methods can also be used with the motion protection apparatus, system and method for an electro-mechanical battery (EMB) system, as described in concurrently filed and co-pending provisional patent application Ser. No. 61/500,394 entitled “MOTION PROTECTION APPARATUS, SYSTEM AND METHOD FOR AN ELECTROMECHANICAL BATTERY SYSTEM” (Attorney Docket No. 15223/6), filed Jun. 23, 2011, which is hereby incorporated by reference.

The foregoing systems and methods can be used with the apparatus, system and method for maintaining a vacuum in an EMB vacuum containment vessel of an electro-mechanical battery (EMB) system, as described in concurrently filed and co-pending provisional patent application Ser. No. 61/500,355 entitled “APPARATUS, SYSTEM AND METHOD FOR PROVIDING CHEMICAL CAPTURE OF GASEOUS EMISSIONS FROM EPOXY-BONDED MATRICES OF A COMPOSITE FLYWHEEL OPERATING IN AN ELECTROMECHANICAL BATTERY SYSTEM” (Attorney Docket No. 15223/2), filed Jun. 23, 2011, which is hereby incorporated by reference.

The foregoing systems and methods can be used with the apparatus, system and method involving the incorporation of luminescent materials, such as, for example, luminescence Eu2+ doped fluorides into a flywheel of an electro-mechanical battery (EMB) system for detecting fatigue damage in the flywheel, as described in concurrently filed and co-pending provisional patent application Ser. No. 61/500,370 entitled “APPARATUS, SYSTEM AND METHOD OF PRESSURE LUMINESCENT MATERIALS INCORPORATED INTO A FLYWHEEL FOR DETECTING FATIGUE DAMAGE IN THE FLYWHEEL OF AN ELECTROMECHANICAL BATTERY SYSTEM” (Attorney Docket No. 15223/3), filed Jun. 23, 2011, which is hereby incorporated by reference.

What is claimed is:

1. A passive gas braking apparatus for braking a flywheel rotating in an electromechanical battery (EMB) system, comprising:
an electro-mechanical battery arrangement having a containment vessel containing a flywheel;
a compressed gas storage arrangement to store compressed gas;
a gas expansion arrangement to receive gas from the containment vessel;
wherein the containment vessel is coupled to the compressed gas storage arrangement,
wherein the containment vessel is coupled to the gas expansion arrangement,
wherein the gas expansion arrangement is coupled to the compressor arrangement.

2. The passive gas braking apparatus of claim 1, wherein the inert gas includes nitrogen.

3. The passive gas braking apparatus of claim 1, further comprising:
an input valve arrangement arranged on a conduit for allowing the gas into the containment vessel.

4. The passive gas braking apparatus of claim 1, further comprising:
an output valve arrangement arranged on a conduit for extracting heated gas out of the containment vessel.

5. The passive gas braking apparatus of claim 1, further comprising:
an input valve arrangement arranged on a conduit for allowing the gas into the containment vessel; and
an output valve arrangement arranged on a conduit for extracting heated gas out of the containment vessel.

6. The passive gas braking apparatus of claim 1, further comprising:
an actuatable ball valve and a magnetic valve arranged on a conduit for allowing the gas into the containment vessel.

7. The passive gas braking apparatus of claim 1, further comprising:
a magnetic valve arranged on a conduit for extracting heated gas out of the containment vessel.

8. The passive gas braking apparatus of claim 1, further comprising:
an actuatable ball valve and a magnetic valve arranged on a conduit for allowing the gas into the containment vessel; and
a magnetic valve arranged on a conduit for extracting heated gas out of the containment vessel.

9. The passive gas braking apparatus of claim 1, further comprising:
a heat exchanger arrangement to extract heat from the heated gas in the gas expansion arrangement.

10. The passive gas braking apparatus of claim 1, wherein the containment vessel is coupled to the compressed gas storage arrangement by a gas conduit for providing stored compressed gas from the compressed gas storage arrangement to the containment vessel.

11. The passive gas braking apparatus of claim 1, wherein the containment vessel is coupled to the gas expansion arrangement by a second gas conduit for extracting heated gas from the containment vessel and returning it to the gas expansion arrangement.

12. The passive gas braking apparatus of claim 1, wherein the containment vessel is coupled to the compressed gas storage arrangement by a gas conduit for providing stored compressed gas from the compressed gas storage arrangement to the containment vessel, and wherein the containment vessel is coupled to the gas expansion arrangement by a second gas conduit for extracting heated gas from the containment vessel and returning it to the gas expansion arrangement.

13. The passive gas braking apparatus of claim 12, further comprising:
an input valve arrangement arranged on the gas conduit for allowing the gas into the containment vessel; and
an output valve arrangement arranged on the second gas conduit for extracting heated gas out of the containment vessel.

14. The passive gas braking apparatus of claim 13, further comprising:
a heat exchanger arrangement to extract heat from the heated gas in the gas expansion arrangement.

15. The passive gas braking apparatus of claim 1, further comprising:
a compressor arrangement to compress the gas, wherein the compressor arrangement is coupled to the compressed gas storage arrangement.

16. A method for braking a flywheel rotating in an electromechanical battery (EMB) system, the method comprising:
providing a compressed gas to an electro-mechanical battery arrangement having a containment vessel containing a rotating flywheel to slow the rotating flywheel; and
after the flywheel has at least slowed because of the gas in the containment vessel, returning heated gas from the containment vessel to a gas expansion arrangement.

17. The method of claim 1, further comprising:
compressing a gas to provide the compressed gas.

18. The method of claim 1, wherein the compressed gas is fed from a compressed gas storage arrangement.

19. The method of claim 1, further comprising:
extracting, using a heat exchanger arrangement, heat from the heated gas in the gas expansion arrangement.

20. The method of claim 1, further comprising:
compressing a gas to provide the compressed gas; and
extracting, using a heat exchanger arrangement, heat from the heated gas in the gas expansion arrangement;
wherein the compressed gas is fed from a compressed gas storage arrangement.

21. A method for braking a flywheel rotating in an electromechanical battery (EMB) system, the method comprising:
compressing a gas to provide the compressed gas;
providing the compressed gas to an electro-mechanical battery arrangement having a containment vessel containing a rotating flywheel to slow the rotating flywheel;
after the flywheel has at least slowed because of the gas in the containment vessel, returning heated gas from the containment vessel to a gas expansion arrangement; and
extracting, using a heat exchanger arrangement, heat from the heated gas in the gas expansion arrangement.
